(19) United States
(12) Patent Application Publication
(10) Pub. No.: US 2009/0014975 A1
(43) Pub. Date: Jan. 15, 2009

(54) TUBULAR BEAM OF TORSION BEAM AXLE TYPE SUSPENSION

(76) Inventor: Jaeyoun Lee, Seoul (KR)

Correspondence Address: MORGAN, LEWIS & BOCKIUS LLP (SF), One Market, Spear Street Tower, Suite 2800, San Francisco, CA, 94105, US

(21) Appl. No.: 11/965,493

(22) Filed: Dec. 27, 2007

(30) Foreign Application Priority Data
Jul. 9, 2007 (KR) 10-2007-0068471

(51) Int. Cl. B60G 9/02

(52) U.S. Cl. 280/124.116

(57) ABSTRACT

The present invention relates to a tubular beam of a torsion beam axle type suspension, which includes a uniform cross-sectional portion with the smallest tail radius and cross-sectional width throughout the tubular beam, a variable cross-sectional area that extends from the uniform cross-sectional portion and gradually increases in the tail radius and cross-sectional width, and an enlarging cross-sectional portion that extends from the variable cross-sectional portion.

Therefore, it is possible to minimize reduction of roll rigidity and improve durability of a tubular beam. Further, it is possible to add understeer characteristics to a tubular beam with an oversteer tendency by minimizing the reduction in transverse rigidity and making a shear center higher.

### CROSS-REFERENCE TO RELATED APPLICATIONS

The present application is based on, and claims priority from, Korean Application Serial Number 10-2007-0068471, filed on Jul. 9, 2007, the disclosure of which is hereby incorporated by reference herein in its entirety.

### FIELD OF THE INVENTION

The present invention relates to a torsion beam axle type suspension, and more particularly, to a tubular beam of a torsion beam axle type suspension in which the torsion beam is formed of a tube.

### BACKGROUND OF THE INVENTION

A torsion beam axle type suspension, a suspension with the left and right trailing arms connected through a cross beam (torsion beam), achieves the same effect as a stabilizer by torsion of the torsion beam due to rolling of a vehicle since the trailing arm is connected to the left and right sides. Further, the torsion beam axle type suspension has a simple configuration with a low manufacturing cost and can ensure relatively good stability in travel, though relatively low in weight, such that it is commonly used for rear wheels of compact FF vehicles.

V-beams formed by pressing a simple flat plate into a V-shape were mainly used for torsion beams in the related art, but it had a problem that the parts and weight increased because a torsion bar and a reinforcement plate were additionally needed.

Accordingly, a tubular beam with a substantially V-shaped cross-section that is manufactured by compressing a circular pipe with a mold has been developed.

FIG. 1 shows a conventional tubular beam 10 with a trailing arm 20 at both ends (a bush 30 for connection with the car body is provided at the front end portion of trailing arm 20 and a bracket 40 for mounting a spindle, spring, and shock absorber is mounted at the rear end portion of the trailing arm).

In tubular beam 10, as shown in FIGS. 1 and 2 of conventional arts, the cross-section is uniformly maintained in a V-shape with the upper surface and the lower surface being in contact (substantially, mounted in an inverse V-shape) from the middle portion (the line I-I) to the enlarging start portion (the line II-II), thereafter gradually widens in an longitudinal axis of the tubular beam 10, and then completely widens into a rectangular shape with four rounded corners at the distal end portion (see FIG. 4A).

In particular, a tail 11 of which the insides are not in complete contact is formed at both lower ends along the front-to-rear direction of the tubular beam 10 to have a predetermined curvature in the cross-section. Tail 11 functions as a torsion bar that is provided to a torsion beam formed by pressing a plate in the related art. The radius of tail 11, i.e. a tail radius R is a factor that has an effect on roll rigidity of tubular beam 10. In general, as tail radius R increases, the roll rigidity has a tendency to increase. Conversely, as tail radius R decreases, the roll rigidity decreases.

On the other hand, as shown in FIG. 3, a shear force by a roll and a bending reaction force by the reaction force of a spring attached at the front end portion of trailing arm 20 are exerted on the tubular beam 10, when a vehicle is in travel.

However, most shear forces offset each other because the shear flow directions are opposite on the upper surface and lower surface of the tubular beam 10.

Further, the shear force and bending reaction force are in opposite directions at a rear tail 11b, such that two forces are offset each other.

At a front tail 11a, however, the directions of the shear force and the bending reaction force are the same and thus a resultant reaction force of the shear force and the bending reaction force is not offset but increased.

As a result, as tail radius R is increased, the roll rigidity also is increased. However, in contrary, local shearing stress is not cancelled by the bending reaction force in front tail 11a but is increased, and thereby the durability of tubular beam 10 is decreased. That is, the roll rigidity and the durability are contrarily related to each other.

On the other hand, FIG. 4A shows a cross-sectional view of the enlarging end portion (III-III) of the tubular beam 10 configured into a rectangular shape shown as in FIG. 4A, positioned substantially at the distal end of the tubular beam 10. FIGS. 4B and 4C illustrate the comparison of tail radius between the enlarging start portion (II-II) and the enlarging end portion (III-III) according to the radius of front and rear tails.

As it can be seen from the comparison of FIGS. 4B and 4C, the example of FIG. 4B has an advantage over the example of FIG. 4C in durability, because the amount of change in the cross-section between the enlarging start portion (II-II) and the enlarging end portion (III-III) in FIG. 4B is smaller than that in the cross-section between the enlarging start portion (II-II) and the enlarging end portion (III-III) in the case of FIG. 4C.

On the other hand, as shown in FIG. 5, a shear center positioned over the tubular beam 10 lowers with increasing the width of the cross-section and is raised with decreasing the width of the cross-section (H1>H2 in W1<W2).

The shear center, i.e., a center about which moment due to shear flow is zero, has an effect on steering characteristics of a vehicle, and understeer appears when the shear center is raised and oversteer appears when the shear center is lowered.

Therefore, for the torsion beam axle type suspension having an oversteer tendency as generally well known, it is preferable that the shear center is high, that is, the cross-sectional width of tubular beam 10 is narrow to increase the height of the shear center.

In contrast, the transverse rigidity is increased with increasing the cross-sectional width, a factor having an effect of transverse rigidity of tubular beam 10, and decreases with decreasing the cross-sectional width.

That is, the shear center and the transverse rigidity have a tendency to be contrary to each other for changes in the same factors (cross-sectional width); therefore, it is very difficult to find a condition to simultaneously meet both of them.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Exemplary embodiments the present invention to provide a tubular beam of a torsion beam axle type suspension that is capable of improving durability and a steering performance by making a shear center higher, in addition to minimizing reduction of roll rigidity and transverse rigidity.

A tubular beam of a torsion beam axle type suspension according to an exemplary embodiment of the present invention comprises a uniform cross-sectional portion, a variable cross-sectional portion, and an enlarging cross-sectional portion.

The uniform cross-sectional portion is formed substantially at the middle of the tubular beam such that radius of front and rear tail are minimum and uniform. The variable cross-sectional portion gradually increases in tail radius from the uniform cross-sectional portion. The cross section of the enlarging cross-sectional portion is enlarged into a rectangular shape with four rounded corners from the variable cross-sectional portion.

The uniform cross-sectional portion has the smallest uniform cross-sectional width throughout the tubular beam. The cross-sectional width gradually increases to the variable cross-sectional portion.

The uniform cross-sectional portion is positioned under a shear center.

A U-shape of the enlarging cross-sectional portion is formed in a smooth curve with a gentle slope at the start portion and the end portion and a slope, which is larger than the slopes at the start portion and the end portion, at the middle portion.

The above features and advantages of the present invention will be apparent from or are set forth in more detail in the accompanying drawings, which are incorporated in and form a part of this specification, and the following Detailed Description of the Invention, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 shows a perspective view of a tubular beam equipped with trailing arms and cross-sectional views for each part;

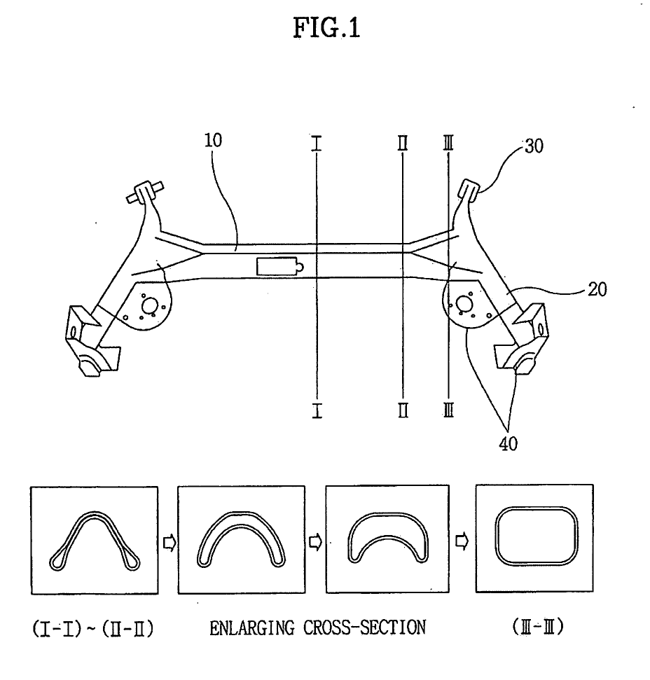

FIG. 2 shows a top view, a front cross-sectional view taken along the line IV-IV and I-I of a tubular beam, and a side cross-sectional view of the uniform cross section portion in the related art;

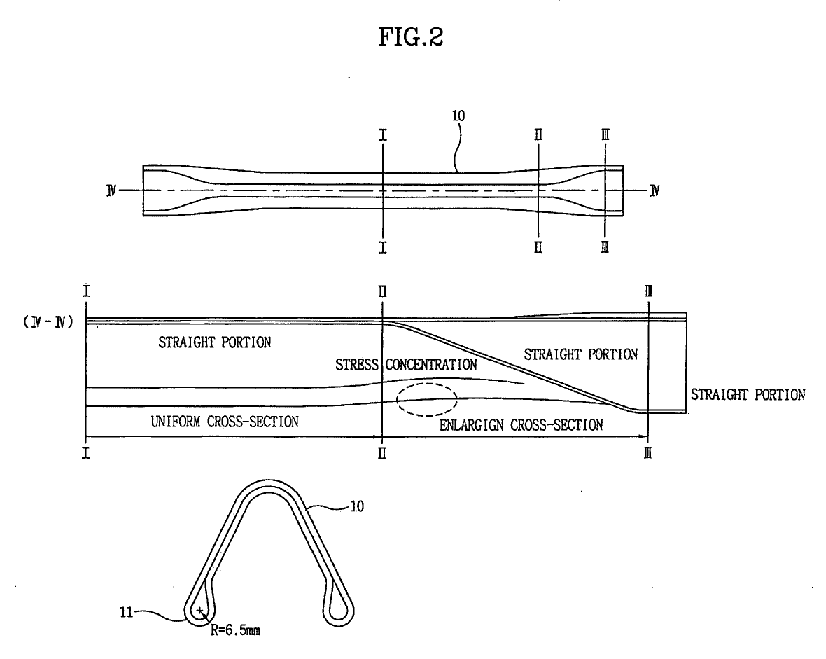

FIG. 3 shows a view illustrating distribution of a reaction force that is generated by a roll and bending reaction force;

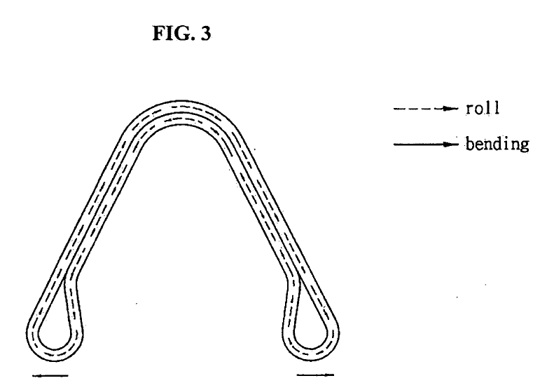

FIG. 4 shows a cross-sectional view of an enlarging cross-sectional portion of a tubular beam and an exemplary view illustrating the relationship between a tail radius and the enlarging cross-sectional portion;

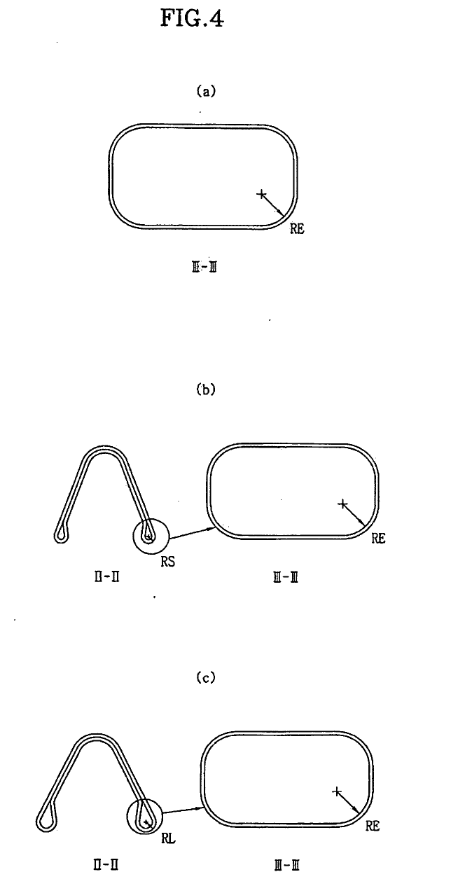

FIG. 5 shows an exemplary view illustrating the relationship between width of first and second tails and a shear center of a tubular beam; and

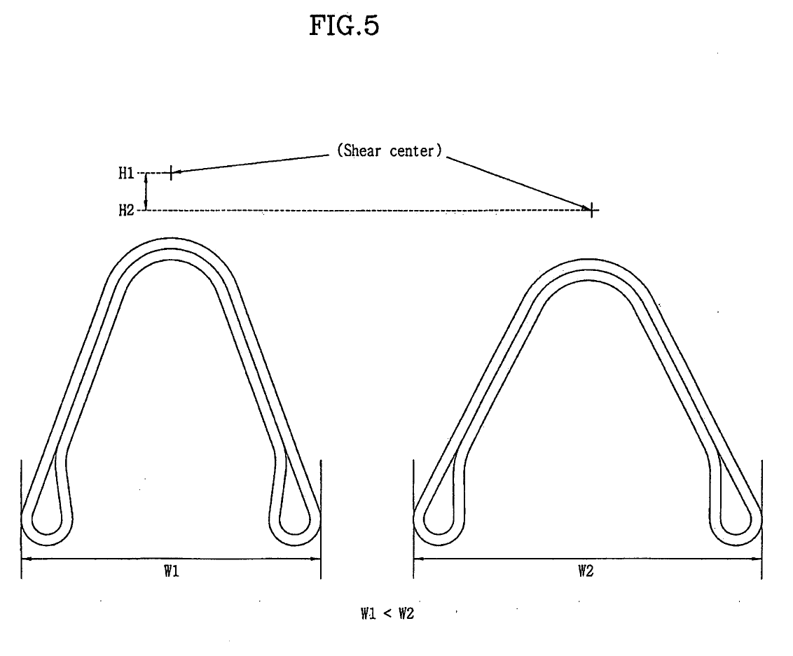

FIG. 6 shows a top view, a front cross-sectional view taken along the line E-E, and a side cross-sectional views of the middle portion (A-A) and an enlarging start portion (C-C) of a tubular beam according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE PREFERRED EMBODIMENTS

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

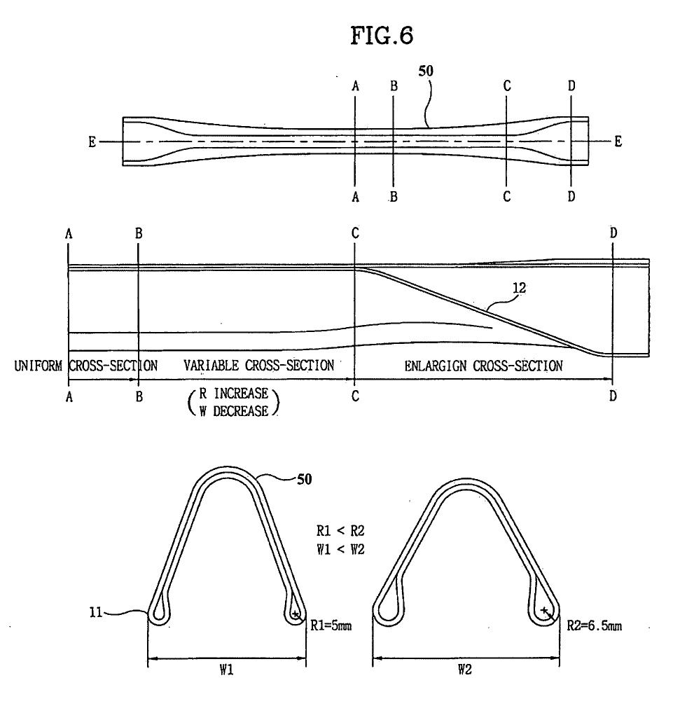

Hereinafter, preferred embodiments of the present invention are described with reference to FIG. 6.

A parent pipe that is 101.6 mm in diameter and 2.8 mm in thickness for a tubular beam is described in this embodiment by way of example.

In the related art, for pipes having the same dimensions, a tubular beam was manufactured to have 6.5 mm tail radius R (the uniform cross-sectional portion between the line I-I and the line II-II) and then enlarged (the enlarging cross-sectional portion between the line II-II and the line III-III).

Further, in the related art, tail radius R of front and rear tails and the cross-sectional width were uniform in the other section than the enlarging cross-sectional portion (the portion between the line II-II and the line III-III) at both ends of a tubular beam. Since the cross-sectional width did not change in this portion, a shear center was not changed as well.

On the other hand, in this exemplary embodiment of the present invention, a uniform cross-sectional portion (the portion between the line A-A and the line B-B) is formed to have 5 mm tail radius R1 of front and rear tails.

The above size is a minimum value of the tubular beam that is possible to be manufactured under the dimensional conditions of the parent pipe (101.6 mm in diameter and 2.8 mm in thickness).

The uniform cross-sectional portion between the line A-A (middle portion) and the B-B (variable cross-sectional start portion) of the tubular beam 50 prevents a discontinuity of cross-sectional change throughout tubular beam; therefore, though short, a predetermined length (e.g. 50 mm) is necessary. Accordingly, the uniform cross-sectional portion is not limited in length, but has only to make the entire shape of the tubular beam smooth.

The uniform cross-sectional portion is positioned under the shear center.

Further, a variable cross-sectional portion (section positioned between the line B-B (variable cross-sectional start portion) and the line C-C (enlarging start portion)) is formed from the distal end portion of uniform cross-sectional portion toward the distal end of the tubular beam.

The variable cross-sectional portion is a connecting portion between the uniform cross-sectional portion and the enlarging cross-sectional portion (section from the line C-C to the line D-D), and the farther away from the uniform cross-sectional portion to the enlarging cross-sectional portion, the more the tail radius gradually increases (R1<R2).

That is, the tail radius (R1=5 mm) of the uniform cross-sectional portion gradually increases up to 6.5 mm at the enlarging start portion (line C-C).

The tail radius (R2=6.5 mm) at the distal end of the variable cross-sectional portion (or the enlarging start portion (line C-C)) may be the same as the tail radius of the portion from the middle portion to the enlarging start portion (section from the line I-I to the line II-II) of the tubular beam in the related art.

In the enlarging start portion (line C-C), the cross-section that is formed in a V-shape before the enlarging cross-sectional portion inside the pipe gradually increases and finally forms a rectangular shape with four rounded corners at the enlarging end portion (line D-D). The length of the enlarging cross-sectional portion, i.e., the portion between the enlarging start portion (line C-C) and the enlarging end portion (line D-D) may be the same as in the related art.

The tubular beam 50 that changes in tail radius according to this exemplary embodiment of the present invention also changes in cross-sectional width, i.e., distance between the front tail and the rear tail, from the variable cross-sectional start portion (line A-A) throughout the entire length.

The cross-sectional width W1 of the uniform cross-sectional portion is the smallest throughout the tubular beam 50, such that the shear center of the uniform cross-sectional portion is at the highest position.

Like the tail radius R1, cross-sectional width W1 is uniform in the uniform cross-sectional portion. Therefore, the height of the shear center is uniform as well.

In the variable cross-sectional portion, i.e., the portion between the variable cross-sectional start portion (B-B) and the enlarging start portion (C-C), cross-sectional width W1 gradually increases up to the cross-sectional width W2 of the enlarging start portion (W1<W2).

Further, beyond the line C-C, i.e. the enlarging start portion, the cross-sectional width correspondingly further increases. The section behind the line C-C may be the same as the section behind the line II-II in the related art.

In the enlarging cross-sectional portion, a V-shape lower surface 12 of the tubular beam 50 may be declined in a straight line with uniform slope from the enlarging start portion (line C-C) to the enlarging end portion (line D-D) with a predetermined slope as shown in FIG. 6, or it may be declined in an entirety smooth curve with a gentle slope at the enlarging start portion (line C-C) and at the enlarging end portion (line D-D) but a slope of the lower surface 12 substantially at the middle of the enlarging cross-sectional portion may be larger than the slopes of the enlarging start portion (line C-C) and the enlarging end portion (line D-D).

Accordingly, the cross-sectional width of the tubular beam according to this exemplary embodiment of the present invention gradually increases from the distal end of the uniform cross-sectional portion to the distal end of the enlarging cross-sectional portion. Changes in the entire cross-sectional width of the tubular beam can be seen from the top view of FIG. 6.

As the cross-sectional width changes as described above, the shear center of the tubular beam according to this exemplary embodiment of the present invention has the highest height at the uniform cross-sectional portion, is then gradually towered through the variable cross-sectional portion, and finally has the lowest height at the enlarging cross-sectional portion at both distal ends of the tubular beam 50.

The tubular beam 50 according to this exemplary embodiment of the present invention is different from tubular beams 10 in the related art in the tail radius, cross-sectional width, and shear center in the section between the middle portion (the line I-I in the related art, the line A-A of the exemplary embodiment of the present invention) and the enlarging start portion (the line II-II in the related art, the line C-C of the exemplary embodiment of the present invention).

Test results of roll rigidity, transverse rigidity, and durability in respect to changes in shape in the related art and an exemplary embodiment of the present invention are as follows.

| | | An exemplary | |
|---|---|---|---|
| | | embodiment of | |
| | Related Art | present Invention | Reference |
| Roll Rigidity | 1.67 | 1.63 | |
| Transverse Rigidity | 82 | 76.2 | 73 under uniform |
| | | | A-A cross-section |
| Durability Index | 0.94 | 1.05 | |

The tail radius according to this exemplary embodiment of the present invention is 5 mm at the middle portion (line A-A), uniformly maintained for a short distance to the variable cross-sectional start portion (line B-B), and then gradually increases up to 6.5 mm at the enlarging start portion (line C-C).

Therefore, compared with the tubular beam in the related art that entirely has a 6.5 mm tail radius in the same section (from the line I-I to the line II-II), in an exemplary embodiment of the present invention, the tail radius entirely reduced and the amount of roll rigidity correspondingly reduced (1.67→1.63, about 2.4%).

However, it can be seen from the table that the durability index increases from 0.94 to 1.05, about 11.7%, by reduction of the tail radius, and the increase of the durability is larger than the reduction of the roll rigidity.

Further, according to this exemplary embodiment of the present invention, the tail radius at the cross-section of the enlarging start portion (line C-C) where the enlarging cross-sectional portion starts is substantially the same in the related art. Therefore, the tubular beam does not rapidly enlarge, such that reduction of durability by rapid deformation is prevented, by reducing the tail radius to increase durability at the section before the enlarging start portion (line C-C).

It is possible for a tubular beam having an oversteer tendency to improve steering performance as in the exemplary invention of the present invention by decreasing the cross-sectional width of the variable cross-sectional portion as compared with the related art, increasing the shear center, and adding understeer characteristics.

This is maintained to the enlarging cross-sectional portion (the cross-sectional portion at the line C-C) where the cross-sectional width becomes the same in the related art, after gradually increasing.

However, since the tubular beam according to this exemplary embodiment of the present invention has a smaller width than the tubular beam in the related art, the transverse rigidity is reduced from 82 to 76.2, about 7.1%, as shown in the above table.

However, compared with the transverse rigidity that is reduced from 82 to 73, about 11.0%, it can be seen that the shape according to this exemplary embodiment of the present invention increases the shear center and minimizes reduction in the transverse rigidity as well.

As described above, according to an exemplary embodiment of the present invention, it is possible to minimize reduction of roll rigidity and improve durability of a tubular beam by changing the cross-sectional shape without increasing the weight of the beam.

Further, for a tubular beam with an oversteer tendency, it is possible to add an understeer characteristics by making the shear center higher and minimizing the reduction in transverse rigidity.

The forgoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiment were chosen and described in order to explain certain principles of the invention and their practical application, to thereby enable others skilled in the art to make and utilize various exemplary embodiments of the present invention, as well as various alternatives and modifications thereof. It is intended that technical spirit and scope of the present invention be defined by the Claims appended hereto and their equivalents.

What is claimed is:

1. A tubular beam of a torsion beam axle type suspension comprising:
a uniform cross-sectional portion that is formed substantially at a middle portion of the tubular beam, wherein radius of front and rear tails are minimum and uniform;
a variable cross-sectional portion that extends from an distal end portion of the uniform cross-sectional portion and the radius of the front and rear tails are gradually increased; and
an enlarging cross-sectional portion that extends from a distal end portion of the variable cross-sectional portion and a cross section of the enlarging cross-sectional portion is gradually enlarged into a rectangular shape with four rounded corners to the distal end of the tubular beam.

2. The tubular beam as defined in claim 1, wherein
a width between the front and rear tails of the uniform cross-sectional portion is minimum and uniform; and
a width between the front and rear tails of the variable cross-sectional portion is gradually increased from the end portion of the uniform cross-sectional portion to a distal end of the enlarging cross-sectional portion.

3. The tubular beam as defined in claim 1, wherein the uniform cross-sectional portion is positioned under a shear center.

4. The tubular beam as defined in claim 3, wherein the shear center of the uniform cross-sectional portion is positioned higher than a shear center of the variable cross-sectional portion, the shear center of the variable cross-sectional portion is positioned higher than a shear center of the enlarging cross-sectional portion, and the shear center of the enlarging cross-sectional portion is positioned higher than a shear center of a distal end of the tubular beam.

5. The tubular beam as defined in claim 4, wherein a length of the uniform cross-sectional portion is about 50 mm.

6. The tubular beam as defined in claim 1, wherein a tower portion of a proximate end portion of the enlarging cross-sectional portion is declined with a first predetermined slope, a distal end portion of the enlarging cross-sectional portion is declined with a second predetermined slope and the enlarging cross-sectional portion is inclined with a third predetermined slope substantially at the middle portion of the enlarging cross-sectional portion, with forming a U-shape of the enlarging cross-sectional portion.

7. The tubular beam as defined in claim 6, wherein the third predetermined slope is larger than the first and second predetermined slope.

8. The tubular beam as defined in claim 1, wherein a lower portion of a proximate-end portion of the enlarging cross-sectional portion is declined with a predetermined slope from an enlarging start portion to an enlarging end portion of the enlarging cross-sectional portion.
